(19) United States
(12) Patent Application Publication
(10) Pub. No.: US 2024/0008412 A1
(43) Pub. Date: Jan. 11, 2024

(54) CROP STRIPPER ROTOR WITH DYNAMIC BALANCING SYSTEM

(71) Applicant: Applequist Mfg., Inc., Assaria, KS (US)

(72) Inventors: Jake Riffel, Gypsum, KS (US); Hank A. Kummer, Lindsborg, KS (US); Billy McQuillan, Gypsum, KS (US); Jeremy Hlad, Wilson, KS (US)

(21) Appl. No.: 18/219,591

(22) Filed: Jul. 7, 2023

Related U.S. Application Data
(60) Provisional application No. 63/359,103, filed on Jul. 7, 2022.

(51) Int. Cl. A01F 12/22; A01D 47/00; A01D 41/14; A01D 89/00

(52) U.S. Cl. CPC A01F 12/22; A01D 47/00; A01D 41/145; A01D 89/002

(57) ABSTRACT

A crop stripper header includes a crop stripper rotor with a central core and a plurality of stripper teeth projecting radially outwardly from the central core. The central core is supported for rotation by first and second end hubs. A dynamic balancing system is provided in each of the end hubs. The dynamic balancing system includes a plurality of steel balls or other suitable weights contained in hollow cavities in the end hubs. The balls are freely moveable within the hollow cavities during rotation of the rotor so that the weights of the balls are distributed to positions within the hollow cavities that tend to neutralize any imbalance in the rotor during operation.

### RELATED APPLICATION

This application claims the benefit of Applicant's U.S. Provisional Patent Application No. 63/359,103 filed on Jul. 7, 2022, the contents of which are incorporated herein by reference.

### BACKGROUND OF THE INVENTION

### Field of the Invention

The present invention relates generally to headers for combines, and in particular, to crop stripper headers with rotors for stripping grain from plants.

### Description of the Related Art

Crop stripper headers are attached to combines for harvesting grain. A stripper header includes a rotating stripper rotor in the front of the header with multiple rows (e.g., eight rows) of stripper teeth sections that strip grain from plants as the combine moves through a field. The stripper rotor rotates backwards relative to a direction of the combine's movement through the field. After the stripper rotor strips the grain, the grain and stripped crop material are deflected back into an auger and pan, moved to the center of the header, and fed into the feeder house of the combine for further threshing.

An advantage of a stripper header compared to a conventional header is that most of the grain is threshed within the header itself instead of within the threshing cylinder and concave of the combine. Thus, the material entering the combine to be threshed is mostly grain and chaff with very little straw and other plant material. The reduced plant material being threshed by the combine can result in a substantial increase in the capacity of the combine.

The stripper rotor of a crop stripper header rotates at a relatively high speed (e.g., 400 to 800 rpm) during use and may cause substantial vibrations or bouncing in the machine if the rotor is not well balanced. There is a need for a stripper rotor with a reduced tendency for such vibrations and bouncing.

### SUMMARY OF THE INVENTION

An object of the present invention is to provide an improved balancing system for a stripper rotor of a crop stripper header.

A further object of the present invention is to provide a dynamic balancing system for a stripper rotor that self-balances the rotor during operation to reduce the vibrations and/or bouncing caused by an out-of-balanced rotor.

A further object of the present invention is to provide a stripper rotor with dynamic balancing system that adapts to changing operating conditions to reduce vibrations and/or bouncing during rotation of the stripper rotor.

To accomplish these and other objects, the present invention provides a crop stripper header having a crop stripper rotor with a central core and a plurality of stripper teeth projecting radially outwardly from the central core. The central core is supported for rotation by first and second end hubs. A dynamic balancing system is provided in each of the end hubs. The dynamic balancing system includes a plurality of steel balls or other suitable weights contained in hollow cavities in the end hubs. The balls are freely moveable within the hollow cavities during rotation of the rotor so that the weights of the balls are distributed to positions within the hollow cavities that tend to neutralize any imbalance in the rotor during operation.

According to one aspect of the invention, a crop stripper rotor is provided, comprising: a central core; a plurality of stripper teeth arranged to project radially outwardly from an outer periphery of the central core; and a dynamic balancing system associated with the central core. The dynamic balancing system comprises a plurality of weights contained in a hollow cavity concentric with an axis of rotation of the central core. The weights are freely moveable within the hollow cavity during rotation of the rotor so that the weights are distributed to positions within the hollow cavity that tend to neutralize any imbalance in the rotor during rotation.

According to another aspect of the invention, a crop stripper header is provided, comprising: at least one crop stripper rotor having a central core and a plurality of stripper teeth projecting radially outwardly from the central core; and a dynamic balancing system associated with the crop stripper rotor. The dynamic balancing system has a plurality of weights contained in a hollow cavity concentric with an axis of rotation of the crop stripper rotor. The weights are freely moveable within the hollow cavity during rotation of the rotor so that the weights are distributed to positions within the hollow cavity that tend to neutralize any imbalance in the rotor during rotation.

Numerous other objects of the present invention will be apparent to those skilled in this art from the following description wherein there is shown and described embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is a perspective view of a crop stripper rotor for a stripper head with a dynamic balancing system according to the present invention.

FIG. 2 is a cross section view of the crop stripper rotor showing the dynamic balancing system.

FIG. 3 is a cross section view of a crop stripper header according to the present invention with a first crop stripper rotor arranged end-to-end with a second crop stripper rotor.

FIG. 4 is a cutaway view of a crop stripper rotor with dynamic balancing systems located at each end of the rotor.

FIG. 5 is a cutaway view of a crop stripper header with a plurality of dynamically balanced crop stripper rotors arranged end-to-end to rotate about a common axis of rotation.

FIG. 6 is a perspective view of a crop stripper rotor with a dynamic balancing system in a separate structure attached to the central core.

### DETAILED DESCRIPTION OF THE INVENTION

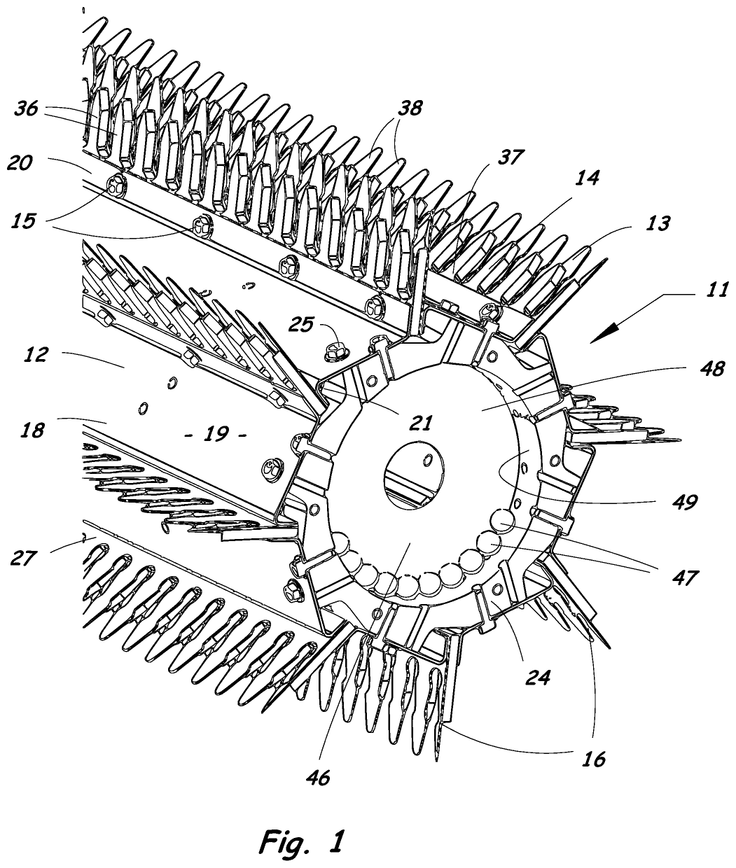

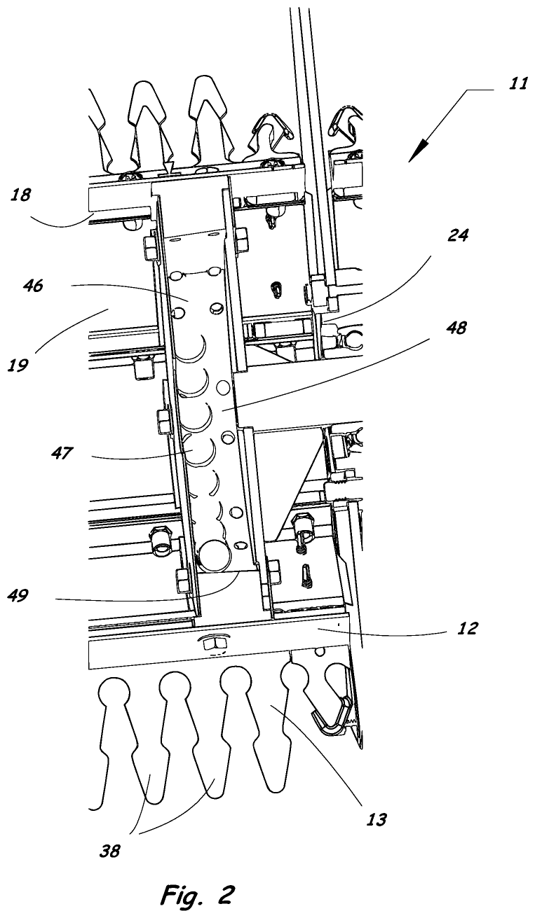

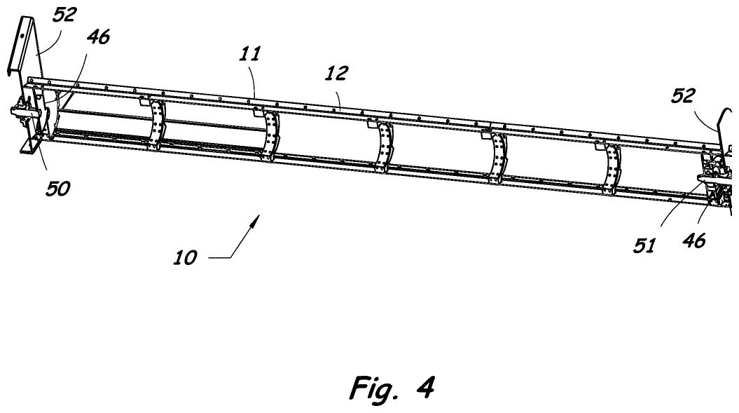

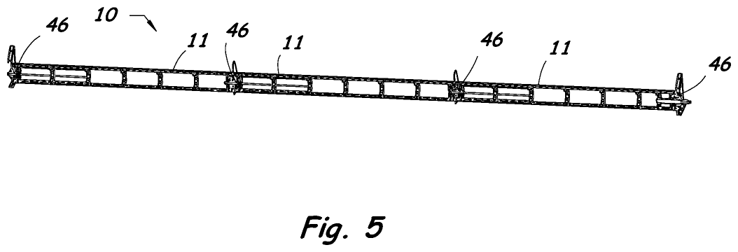

A crop stripper header 10 having a stripper rotor 11 with a dynamic balancing system according to the present invention will now be described with reference to FIGS. 1 to 6 of the accompanying drawings.

The crop stripper rotor 11 includes a central core 12, a plurality of stripper Meth sections 13, a plurality of backer plates 14, and a plurality of threaded fasteners 15 for securing the stripper teeth sections 13 and backer plates 14 to the central core 12.

The stripper teeth sections 13 and backer plates 14 are arranged in multiple, axially extending rows of stripper teeth assemblies 16 along the central core 12. The rows of stripper teeth assemblies 16 are angularly spaced from each other around the central core 12. Each row of stripper teeth assemblies 16 includes a plurality of stripper teeth sections 13 and backer plates 14 positioned end-to-end with other stripper teeth sections 13 and backer plates 14.

The central core 12 includes a plurality of bent sheet metal sections 18 arranged to form a generally cylindrical shape. The bent sheet metal sections 18 each have a flat portion 19 and flanges 20, 21 extending in an axial direction along the side edges of the flat portion 19. The bent sheet metal sections 18 have a generally Z-shape in cross section, with a first one of the flanges 20 (i.e., the leading flange relative to a direction of rotation) extending radially outwardly from the flat portion 19, and a second one of the flanges 21 (i.e., the trailing flange relative to the direction of rotation) extending radially inwardly from the flat portion 19.

The bent sheet metal sections 18 are secured to central end hubs 24 positioned at each end of the central core 12, and central intermediate hubs (not shown) da spaced locations along the length of the rotor 11. The central hubs 24 have threaded mounting holes in mounting surfaces that are aligned with corresponding mounting bores in the flat portions 19 of the bent sheet metal sections 18 to ensure a proper fit and assembly of the central core 12. The threaded mounting holes in the central hubs can be formed by cutting threads into the central hub itself, or by fixing threaded structures, such ml nuts, to the inner facing periphery of the mounting holes. Threaded fasteners 25 extend through the mounting bores in the flat portions 19 of the sheet metal sections 18 and into the threaded mounting holes in the central hub 24 to securely fasten the sheet metal sections 18 to the central hubs 24.

The stripper teeth sections 13 are arranged to project radially outwardly from an outer periphery of the central core 12. Each of the stripper teeth sections 13 has stripping teeth 38 and a mounting base 27 with an alignment and mounting system to facilitate assembling the stripper teeth sections 13 to the central core 12. The backer plates 14 each have backing teeth 36 and a backing base 37 corresponding to the mounting base 27 of the stripper teeth sections 13. The mounting bases 27 of the stripper teeth sections 13 and the backing base 37 of the backer plates 14 are sandwiched between opposed flanges 20, 21 of the sheet metal sections 18.

The crop stripper rotor 11 rotates at a relatively high speed (e.g., 400 to 800 rpm) during use. A dynamic balancing system 46 is provided to minimize vibrations and bouncing in the stripper rotor 11.

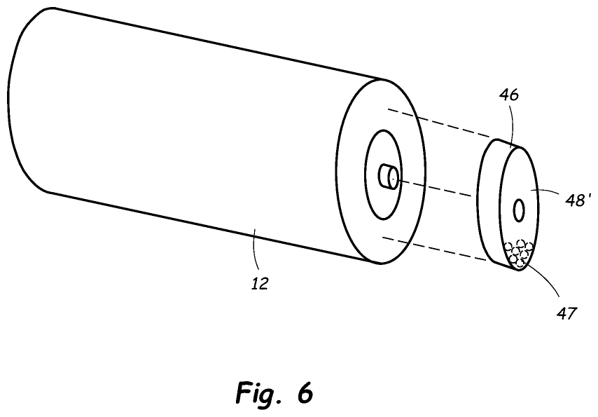

The dynamic balancing system 46 includes a plurality of weights 47 contained in a hollow cavity 48 in the central core 12. For example, the weights 47 can be contained in hollow cavities 48 defined by compartments within the central end hubs 24 positioned at each end of the central core 12. Alternatively, the hollow cavities can be within central intermediate hubs in the central core 12, or in separate structures 48′ (FIG. 6) attached to and concentric with the central core 12. In either case, the hollow cavity 48 includes an annular surface 49 concentric with an axis of rotation of the central core, and the annular surface 49 restricts movement of the plurality of weights 47 in a radially outward direction.

The weights 47 can be balls, such as chrome steel balls. The size and number of the weights 47 needed for effective balancing will be based on a diameter of the annular surface 49, the speed of rotation of the stripper rotor 11, and the size of the rotor being balanced. The balancing system 46 is particularly useful for reducing vibrations and undesirable bouncing of the stripper rotor 11 at rotation speeds that cause the rotor 11 to resonate with maximum deflections.

The weights 47 are freely moveable within the hollow cavity 48 and are forced radially outwardly into engagement with the annular surface 49 by centrifugal force during rotation of the rotor 11. The annular surface 49 restricts radially outward movement of the weights 47, but allows the weights 47 to be distributed to positions within the hollow cavity 48 that tend to neutralize any imbalance in the rotor 11 during rotation.

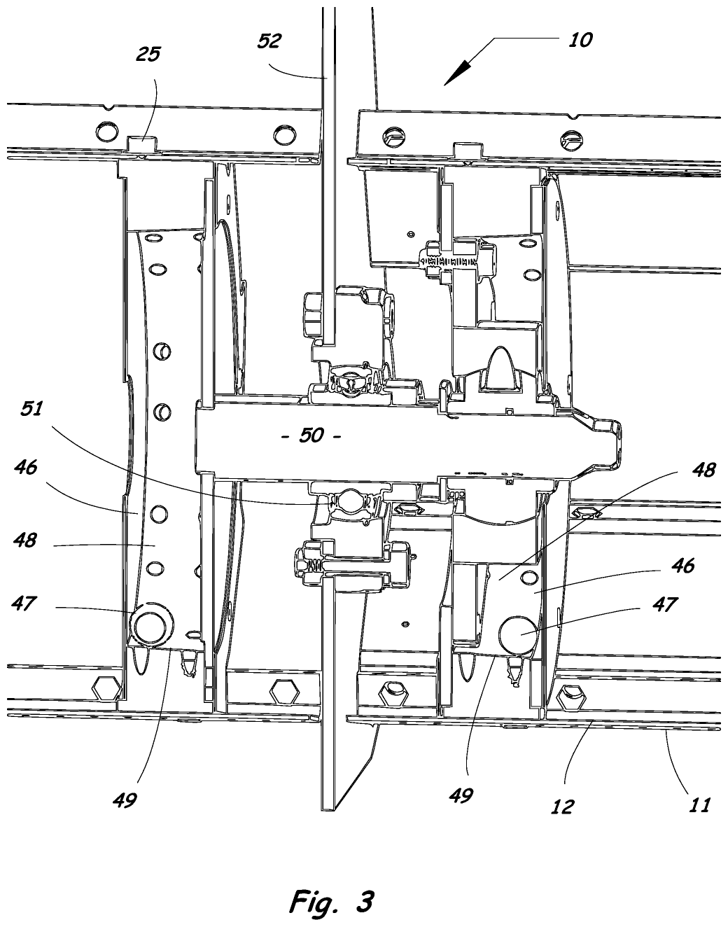

The crop stripper header 10 can have a plurality of stripper rotors 11 arranged end-to-end for rotation about a common axis. The dynamic balancing system 46 can be provided in hollow cavities 48 within the central end hubs 24 of each of the stripper rotors 11 to help neutralize vibrations caused by an imbalance of the rotors 11 during high-speed rotation. As shown in FIG. 3, the stripper rotors 11 can be supported for rotation in the header 10 by a shaft 50 extending between the central end hubs 24 of adjacent rotors 11, and a bearing 51 connected to a support structure 52 in the header 10.

While the invention has been described in connection with specific embodiments thereof, it is to be understood that this is by way of illustration and not of limitation, and the scope of the appended claims should be construed as broadly as the prior art will permit.

What is claimed is:

1. A crop stripper rotor, comprising:
a central core;
a plurality of stripper teeth arranged to project radially outwardly from an outer periphery of the central core; and
a dynamic balancing system associated with the central core, said dynamic balancing system comprising a plurality of weights contained in a hollow cavity concentric with an axis of rotation of the central core, said weights being freely moveable within said hollow cavity during rotation of the rotor so that the weights are distributed to positions within said hollow cavity that tend to neutralize any imbalance in the rotor during rotation.

2. The crop stripper rotor according to claim 1, wherein said plurality of weights are balls.

3. The crop stripper rotor according to claim 1, wherein said plurality of weights are chrome steel balls.

4. The crop stripper rotor according to claim 3, wherein said central core comprises a first end hub, and said hollow cavity comprises a first compartment located in said first end hub to contain said steel balls, said first compartment having a circular outer periphery concentric with the axis of rotation of the central core.

5. The crop stripper rotor according to claim 4, wherein said central core comprises a second end hub, and said hollow cavity comprises a second compartment located in said second end hub to contain said steel balls, said second compartment having a circular outer periphery concentric with the axis of rotation of the central core.

6. The crop stripper rotor according to claim 1, wherein said central core comprises a first end hub, and said hollow cavity comprises a first compartment located in said first end hub to contain said weights, said first compartment having a circular outer periphery concentric with the axis of rotation of the central core.

7. The crop stripper rotor according to claim 6, wherein said central core comprises a second end hub, and said hollow cavity comprises a second compartment located in said second end hub to contain said weights, said second compartment having a circular outer periphery concentric with the axis of rotation of the central core.

8. The crop stripper rotor according to claim 1, wherein said dynamic balancing system is a separate structure attached to and concentric with the central core.

9. A crop stripper header, comprising:
at least one crop stripper rotor having a central core and a plurality of stripper teeth projecting radially outwardly from the central core; and
a dynamic balancing system associated with the crop stripper rotor, said dynamic balancing system comprising a plurality of weights contained in a hollow cavity concentric with an axis of rotation of the crop stripper rotor, said weights being freely moveable within said hollow cavity during rotation of the rotor so that the weights are distributed to positions within said hollow cavity that tend to neutralize any imbalance in the rotor during rotation.

10. The crop stripper header according to claim 9, wherein said plurality of weights are balls.

11. The crop stripper header according to claim 9, wherein said plurality of weights are chrome steel balls.

12. The crop stripper header according to claim 11, wherein said central core comprises a first end hub, and said hollow cavity comprises a first compartment located in said first end hub to contain said steel balls, said first compartment having a circular outer periphery concentric with the axis of rotation of the central core.

13. The crop stripper header according to claim 12, wherein said central core comprises a second end hub, and said hollow cavity comprises a second compartment located in said second end hub to contain said steel balls, said second compartment having a circular outer periphery concentric with the axis of rotation of the central core.

14. The crop stripper header according to claim 9, wherein said central core comprises a first end hub, and said hollow cavity comprises a first compartment located in said first end hub to contain said weights, said first compartment having a circular outer periphery concentric with the axis of rotation of the central core.

15. The crop stripper header according to claim 14, wherein said central core comprises a second end hub, and said hollow cavity comprises a second compartment located in said second end hub to contain said weights, said second compartment having a circular outer periphery concentric with the axis of rotation of the central core.

16. The crop stripper header according to claim 9, wherein said dynamic balancing system is a separate structure attached to and concentric with the crop stripper rotor.

17. The crop stripper header according to claim 9, wherein said at least one crop stripper rotor comprises a plurality of crop stripper rotors arranged end-to-end for rotation about a common axis, and wherein said dynamic balancing system comprises a plurality of dynamic balancing systems associated with said crop stripper rotors.
